(19) United States
(12) Patent Application Publication
(10) Pub. No.: US 2015/0206291 A1
(43) Pub. Date: Jul. 23, 2015

(54) IMAGE PROCESSING APPARATUS AND METHOD USING SHARPENING FILTERING

(71) Applicant: SAMSUNG ELECTRONICS CO., LTD., Suwon-si (KR)

(72) Inventors: Won-ho CHO, Suwon-si (KR); Tae-chan KIM, Yongin-si (KR)

(73) Assignee: SAMSUNG ELECTRONICS CO., LTD., Suwon-si (KR)

(21) Appl. No.: 14/590,244

(22) Filed: Jan. 6, 2015

(30) Foreign Application Priority Data
Jan. 22, 2014 (KR) 10-2014-0007934

(51) Int. Cl. G06T 5/00; G06T 5/20

(52) U.S. Cl. CPC G06T 5/004; G06T 5/20; G06T 2207/20024; G06T 2207/20192; G06T 2207/20182; G06T 2207/20004

(57) ABSTRACT

Provided are an image processing apparatus and an image processing method using sharpening filtering. The image processing method includes filtering input image data using a plurality of directional filters, comparing a plurality of filtering results with a threshold value that corresponds to the filtering results, selectively aggregating a plurality of output values of the directional filters according results of the comparison, and performing a first calculation on the input image data and a result of the selective aggregation.

### CROSS-REFERENCE TO RELATED APPLICATION

This application claims priority from Korean Patent Application No. 10-2014-0007934, filed on Jan. 22, 2014, in the Korean Intellectual Property Office, the disclosure of which is incorporated herein in its entirety by reference.

### BACKGROUND

Exemplary embodiments relate to an image processing apparatus and method. Exemplary embodiments relate to an image processing apparatus and method using sharpening filtering. Therefore, image quality may be increased and sharpening noise may be reduced.

Due to the hardware development for reproducing and storing high-resolution or high quality video content, there is an increased demand for a video codec that efficiently decodes and encodes high-resolution or high quality video content. According to the related art, a video codec encodes a video based on a macroblock having a predetermined size.

There are various methods for increasing the quality of encoded/decoded images, e.g., a filtering method which may be used for removing blocking artifacts or noise. An example of the filtering method includes performing sharpening filtering operations to sharpen edges of an image. For example, the sharpening filtering includes unsharpening filtering operations for performing subtraction operations in relation to low frequency filtered image data and original image data. However, related art sharpening filtering (or unsharpening filtering) operations may increase sharpening noise or excessively sharpen high contrast regions. Thus, related art sharpening filtering (or unsharpening filtering) may cause reduction of image quality.

### SUMMARY

Exemplary embodiments provide an image processing apparatus and method capable of enhancing low contrast edges and reducing sharpening noise when sharpening images.

According to an aspect of an exemplary embodiment, there is provided an image processing method including filtering input image data using a plurality of directional filters, comparing a plurality of filtering results with a threshold value that corresponds to the filtering results, selectively aggregating at least a plurality of output values of the directional filters according to results of the comparison, and performing a first calculation on the input image data and a result of the selective aggregation.

The performing the first calculation may include generating output image data by adding the input image data and the result of the selective aggregation.

A total sum of filtering coefficients of the directional filters may be equal to a mask coefficient of an unsharpening kernel.

The filtering may include filtering a filtering result obtained with the directional filters by using at least one residual filter.

A total sum of filter coefficients of the directional filters and a filter coefficient of the at least one residual filter may be equal to a mask coefficient of an unsharpening kernel.

The directional filters may include at least one of a horizontal type filter, a vertical type filter, and a diagonal type filter.

The directional filters may include m directional filters and m comparing devices which corresponds to the m directional filters, and output values of less than m directional filters may be aggregated according to the results of the comparison, and m is an integer equal to or greater than 2.

N unsharpening kernels may receive the input image data and execute an unsharpening filtering algorithm. The directional filters and a plurality of comparing devices for performing comparison operations may be provided in each of the N unsharpening kernels, and N is an integer equal to or greater than 2.

The result of the selective aggregation may be provided from each of the N unsharpening kernels, and the performing the first calculation may include adding the input image data and the result of the selective aggregation of a N number of unsharpening kernels.

A plurality of comparing devices may be provided with respect to the directional filters, and an identical threshold value or a plurality of different threshold values may be provided to the comparing devices.

Each of the comparing devices may output an output value of a corresponding directional filter in response to the output value of the corresponding directional filter being equal to or greater than a threshold value, and may output a value equal to 0 in response to the output value of the corresponding direction filter being less than the threshold value.

According to another aspect of an exemplary embodiment, there is provided an image processing apparatus including at least one unsharpening kernel configured to execute an unsharpening filtering algorithm, and a calculator configured to generate output image data by performing a first calculation on an output of the at least one unsharpening kernel and input image data. The at least one unsharpening kernel includes a directional filter set which includes a plurality of directional filters for filtering the input image data; a comparing unit which includes a plurality of comparing devices respectively provided with respect to the directional filters, and configured to compare a plurality of filtering results with a threshold value that corresponds to results of the filtering, and an aggregation device configured to aggregate a plurality of output values of the directional filters according to results of the comparison from the plurality of comparing devices, and provide an aggregation result as an output of the at least one unsharpening kernel.

According to an aspect of an exemplary embodiment, there is provided an image processing method including identifying a mask coefficient of an unsharpened kernel according to an unsharpening filtering algorithm, determining a plurality of coefficients of a plurality of directional filters based on the identified mask coefficient, determining a plurality of locations which correspond to the directional filters, determining a coefficient of at least one residual filter such that the coefficient is equal to a difference between the identified mask coefficient and a total sum of the coefficients of the directional filters, and disposing the directional filters and the at least one residual filter in the unsharpening kernel such that an input image passes through the directional filters and the at least one residual filter.

### BRIEF DESCRIPTION OF THE DRAWINGS

Exemplary embodiments of the inventive concept will be more clearly understood from the following detailed description taken in conjunction with the accompanying drawings in which:

FIG. 1 is an exemplary block diagram of an image processing apparatus according to an embodiment of the inventive concept;

FIG. 2 is a block diagram of an embodiment of a filtering unit of FIG. 1;

FIGS. 3A and 3B are exemplary block diagrams of an image processing operation performed in an unsharpening kernel of FIG. 2;

FIG. 4 is a detailed exemplary block diagram of a sharpening filtering unit according to an embodiment of the inventive concept;

FIGS. 5, 6, 7A and 7B are block diagrams of an embodiment of the sharpening filtering unit of FIG. 4;

FIG. 8 is a view of images that have undergone an unsharpening filtering process according to an embodiment of the inventive concept;

FIG. 9 is a view of a change in a low contrast edge profile according to the unsharpening filtering process according to an embodiment of the inventive concept;

FIG. 10 is a block diagram of a sharpening filtering unit according to another embodiment of the inventive concept;

FIG. 11 is a block diagram of filters composing the unsharpening kernel according to an embodiment of the inventive concept;

FIG. 12 is a flowchart of an image processing method using sharpening filtering according to an embodiment of the inventive concept;

FIG. 13 is a flowchart an image processing method using sharpening filtering according to another embodiment of the inventive concept;

FIG. 14 is a block diagram of an application processor including the image processing apparatus according to an embodiment of the inventive concept; and

FIG. 15 is an exemplary view of a mobile device including the image processing apparatus according to an embodiment of the inventive concept.

### DETAILED DESCRIPTION OF THE EXEMPLARY EMBODIMENTS

Hereinafter, one or more exemplary embodiments of the inventive concept will now be described more fully with reference to the accompanying drawings, in which exemplary embodiments of the inventive concept are shown to fully convey the inventive concept to one of ordinary skill in the art. As the inventive concept allows for various changes and numerous embodiments, particular embodiments will be illustrated in the drawings and described in detail in the written description. However, this is not intended to limit the inventive concept to particular modes of practice, and it is to be appreciated that all changes, equivalents, and substitutes that do not depart from the spirit and technical scope of the inventive concept are encompassed in the inventive concept. Throughout the specification, like reference numerals in the drawings denote like elements. Sizes of elements in the drawings may be exaggerated for clear explanation of the embodiments.

The terms used in the present specification are merely used to describe particular embodiments, and are not intended to limit the inventive concept. An expression used in the singular form encompasses the expression in the plural form, unless it has a clearly different meaning in the context. In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless defined otherwise, all terms used in the description including technical or scientific terms have the same meaning as generally understood by one of ordinary skill in the art. It will be further understood that terms, such as those defined in commonly used dictionaries, should be interpreted as having a meaning that is consistent with their meaning in the context of the related art, and should not be interpreted as having ideal or excessively formal meanings unless it is clearly defined in the specification.

As used herein, the term “and/or” includes any and all combinations of one or more of the associated listed items. Expressions such as “at least one of,” when preceding a list of elements, modify the entire list of elements and do not modify the individual elements of the list.

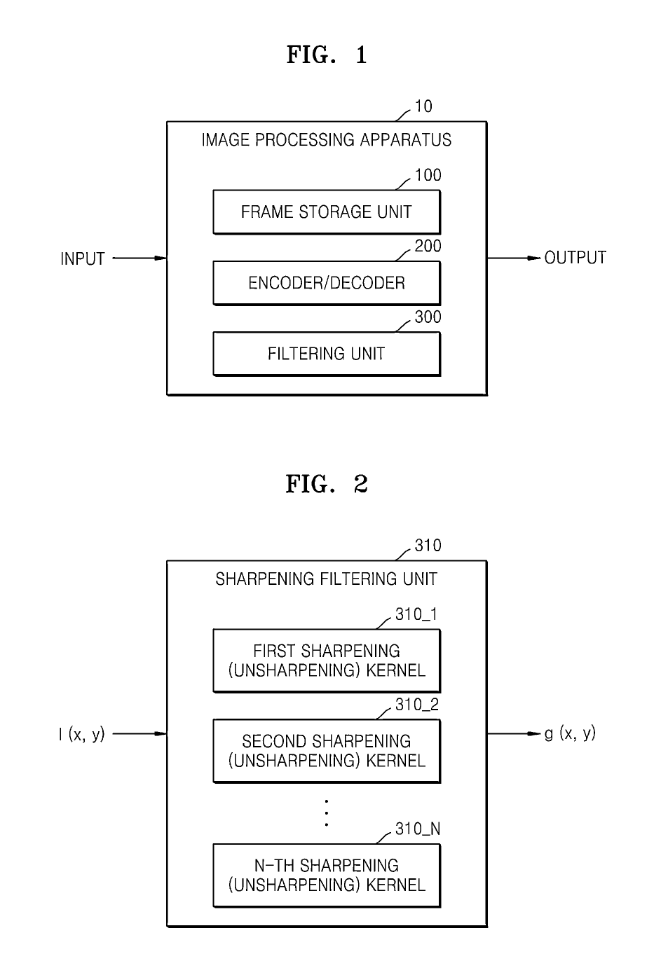

FIG. 1 is an exemplary block diagram of an image processing apparatus 10 according to an exemplary embodiment of the inventive concept. As illustrated in FIG. 1, the image processing apparatus 10 may receive an input signal (Input) and perform data encoding or decoding on the input signal (Input). Also, the image processing apparatus 10 may perform an image processing operation such as a filtering operation. The image processing apparatus 10 may include a frame storage unit 100, an encoder/decoder 200, and a filtering unit 300 so as to generate an output signal (Output) based on various processing operations performed on the input signal (Input).

The image processing apparatus 10 may, for example, receive frame unit image data as the input signal (Input), and store the frame unit image data. The frame storage unit 100 may store the frame unit image data. The encoder/decoder 200 may encode or decode signal according to a method based on various formats. For example, in order to perform an encoding operation according to an inter-prediction method, motion estimation and compensation technologies may be applied. In addition, the encoder/decoder 200 may perform intra-prediction, frequency conversion, quantization, and the like. Thus, encoded image data is generated.

The filtering unit 300 may include at least one filter for noise removal or image enhancement. For example, various types of filters may be included in the filtering unit 300. At least one of a mean filter, a low pass filter, and a high pass filter may be included in the filtering unit 300. According to an exemplary embodiment of the inventive concept, a filter may be included to execute a sharpening filtering algorithm so as to obtain an image sharpening effect. For example, at least one high pass filter may be included in the filtering unit 300. Alternatively, when an unsharpening masking algorithm is applied, a low pass filter for performing a low pass filtering operation on image data may be included in the filtering unit 300.

In order to obtain the image sharpening effect using the sharpening filtering algorithm (or, the unsharpening filtering algorithm) as described above, the image data may be processed using a high pass filter. A total sum of mask coefficients of the high pass filter may be positive. For example, a central mask coefficient may be positive, and surrounding coefficients may be negative. Also, the total sum of the mask coefficients may be equal to at least 0. For example, the total sum of the mask coefficients may be equal to 1.

Alternatively, an unsharpening method may be applied to obtain an image sharpening effect. In order to obtain the image sharpening effect using the unsharpening method, low frequency components in an image may be reduced by performing subtraction operations in relation to low frequency filtered image data and original image data. Hereinafter, a sharpening operation according to the exemplary embodiments of the inventive concept may be any one of a sharpening operation using the above-described unsharpening filtering algorithm and a sharpening operation using a sharpening filter (or a high pass filter).

As described above, the filtering unit 300 may include at least one sharpening filter (hereinafter, the term “sharpening filter” includes a term that includes the term “unsharpening filter”) to obtain the image sharpening effect. The sharpening filter may have a mask value for obtaining the image sharpening effect. For example, the sharpening filter may have N*N number of mask coefficients (where N is an integer equal to or greater than 2). In addition, according to an exemplary embodiment of the inventive concept, a sharpening filter may be decomposed into a plurality of directional filters. For example, the sharpening filter may be decomposed into at least two directional filters that generate output values that represent a degree of change in brightness of a pixel in at least two directions. The plurality of directional filters may correspond to edge detection filters.

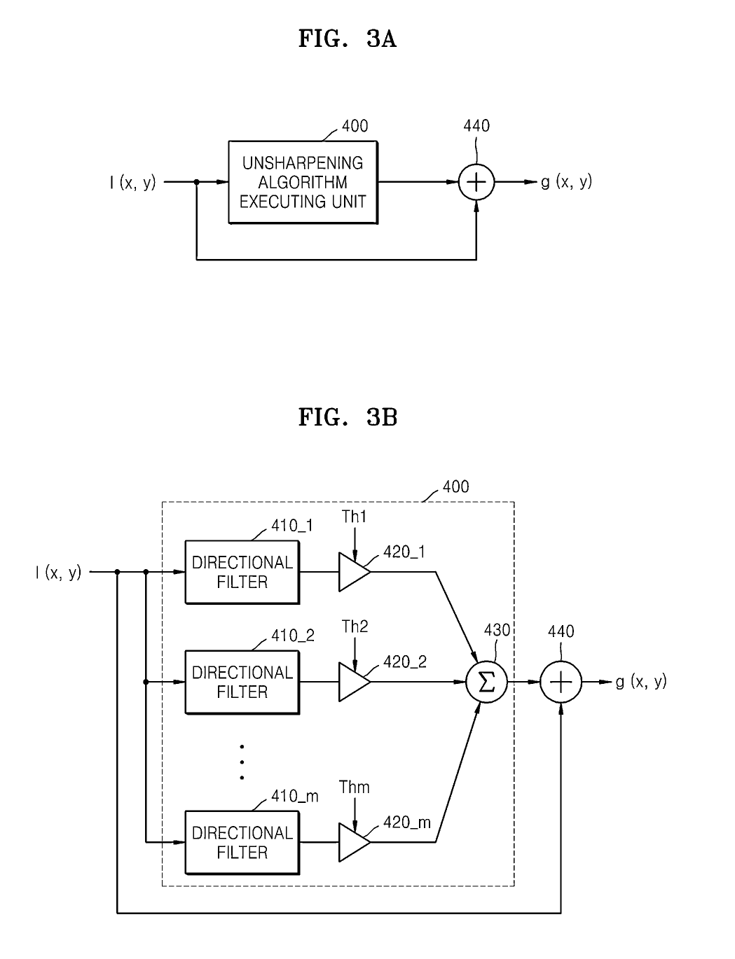

Hereinafter, operations of the filtering unit 300 of FIG. 1 are described. FIG. 2 is a block diagram of an embodiment of the filtering unit 300 of FIG. 1.

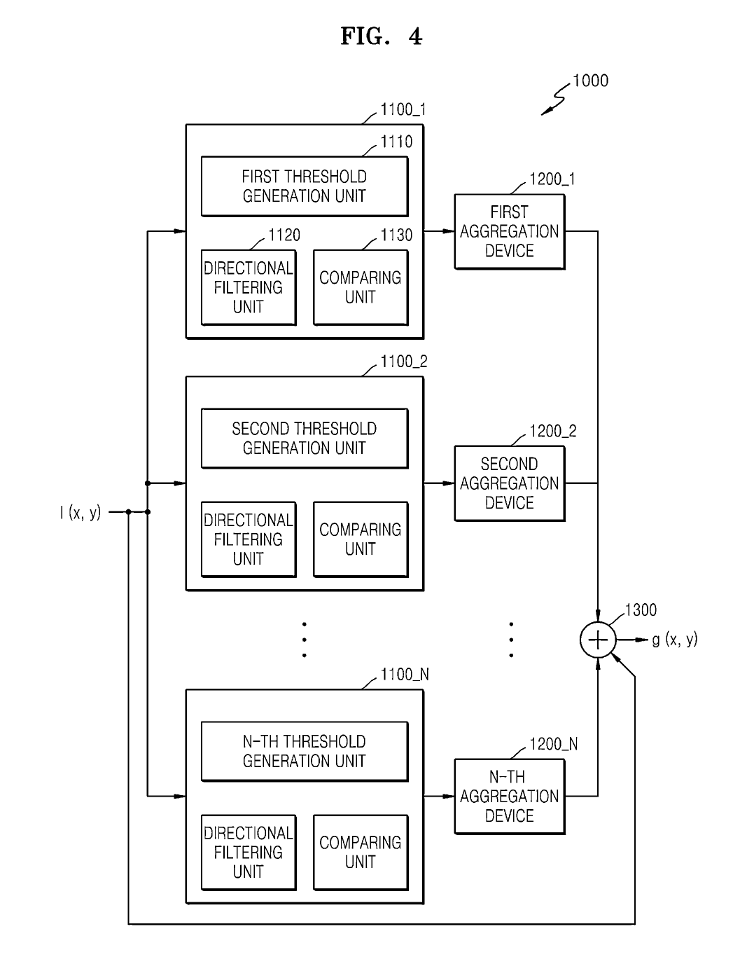

As illustrated in FIG. 2, the filtering unit 300 may include at least one type of filter. For example, the filtering unit 300 may include a sharpening filtering unit 310 to obtain the image sharpening effect. The sharpening filtering unit 310 may include a plurality of kernels, e.g., first to N-th sharpening kernels (or unsharpening kernels) 310_1 to 310_N. The sharpening filtering unit 310 may receive and filter input image data (I(x,y)). Thus, output image data (g(x,y)) is generated. Each of the first to N-th sharpening kernels 310_1 to 310_N may include at least one filter, e.g., as described above, a sharpening filter or an unsharpening filter. Each of the first to N-th sharpening kernels 310_1 to 310_N may execute a sharpening filtering algorithm (or an unsharpening filtering algorithm), and have unsharpening kernel coefficients. Each of the N sharpening kernels may be a sharpening filter. According to the exemplary embodiments of the inventive concept, the sharpening filtering unit 310 may include an unsharpening kernel for executing an unsharpening filtering algorithm. An example of operations of elements of FIG. 2 will be described below with reference to FIGS. 3A and 3B.

FIGS. 3A and 3B are exemplary block diagrams of an image processing operation performed in the unsharpening kernel of FIG. 2. FIG. 3A illustrates an element included in each unsharpening kernel in order to execute an unsharpening filtering algorithm, and FIG. 3B illustrates an exemplary embodiment of the element for executing the unsharpening filtering algorithm of FIG. 3A.

The unsharpening kernel may include an unsharpening algorithm executing unit 400 and a calculator 440. The unsharpening algorithm executing unit 400 receives and filters the input image data (I(x,y)), and outputs the filtering result. The calculator 440 may calculate the input image data (I(x,y)) and an output of the unsharpening algorithm executing unit 400. Thus, the output image data (g(x,y)) is generated. For example, the calculator 440 may include an adding device, and generate the output image data (g(x,y)) by adding the input image data (I(x,y)) and the output of the unsharpening algorithm executing unit 400.

As illustrated in FIG. 3B, the unsharpening algorithm executing unit 400 may include a plurality of directional filters 410_1 to 410_m, a plurality of comparing devices 420_1 to 420_m, and an aggregation device 430. The unsharpening algorithm executing unit 400 of FIG. 3B may be an element included in a single unsharpening kernel, and the calculator 440 may aggregate outputs of at least one unsharpening kernel. The plurality of directional filters 410_1 to 410_m may be a directional filter set.

In order to execute the unsharpening filtering algorithm, the plurality of directional filters 410_1 to 410_m may be determined according to a mask coefficient of an unsharpening filter. For example, the unsharpening filter may have a predetermined size, e.g., may be a filter having a size of A*A (where A is an integer equal to or greater than 2). A total sum of coefficients of the plurality of directional filters 410_1 to 410_m may be the same as the mask coefficient of the unsharpening filter. Also, the plurality of directional filters 410_1 to 410_m may each have a coefficient for detecting edges in different directions. For example, the plurality of directional filters 410_1 to 410_m may be a filter for detecting edges in at least one of a horizontal direction, a vertical direction, and a diagonal direction.

A size of the unsharpening filter and respective sizes of the plurality of directional filters 410_1 to 410_m may be the same or different. For example, each of the plurality of directional filters 410_1 to 410_m may be a filter having a size of A*A (where A is an integer equal to or greater than 2). Alternatively, each of the plurality of directional filters 410_1 to 410_m may be smaller than the unsharpening filter. Respective positions of the plurality of directional filters 410_1 to 410_m may be determined such that the total sum of the coefficients of the plurality of directional filters 410_1 to 410_m is equal to the mask coefficient of the unsharpening filter.

The plurality of comparing devices 420_1 to 420_m may generate a comparison result by comparing output values of the plurality of directional filters 410_1 to 410_m and predetermined threshold values Th1 to Thm. For example, an output value of a first directional filter 410_1 and a first threshold value Th1 are provided to a first comparing device 420_1. Then, the first comparing device 420_1 may provide a result obtained by comparing the output of the first directional filter 410_1 and the first threshold value Th1 to the aggregation device 430. For example, the first threshold value Th1 may be a reference value for determining whether the output of the first directional filter 410_1 is sharpening noise. Then, according to the result obtained by comparing the output of the first directional filter 410_1 and the first threshold value Th1, the first comparing device 420_1 may output a value of “0” or provide a value that corresponds to the output value of the first directional filter 410_1 to the aggregation device 430. In particular, when the output value of the first directional filter 410_1 is equal to or greater than the first threshold value Th1, the first comparing device 420_1 may provide the value that corresponds to the output of the first directional filter 410_1 to the aggregation device 430.

The plurality of directional filters 410_1 to 410_m filters the input image data I(x,y) and provides the filtering results. Some outputs of the plurality of directional filters 410_1 to 410_m may be equal to or greater than threshold values that respectively correspond to the some outputs. However, other outputs of the plurality of directional filters 410_1 to 410_m may be smaller than threshold values that respectively correspond to the other outputs. Therefore, the aggregation device 430 may generate a result obtained by only aggregating some of the outputs of the plurality of directional filters 410_1 to 410_m.

According to the operations described above, a direction filter set included in each of the unsharpening kernels selectively aggregates some output values of the plurality of directional filters 410_1 to 410_m according to the predetermined threshold values Th1 to Thm. Also, the aggregation results from the plurality of unsharpening kernels are provided to the calculator 440. Thus, an output of the calculator 440 is generated as a final sharpening value.

The threshold values Th1 to Thm may be a same value or a different value. A threshold value generation unit (not shown) for generating the threshold values Th1 to Thm may be disposed inside or outside of an unsharpening kernel. Alternatively, the threshold values Th1 to Thm may be generated by different threshold value generation units (not shown). Accordingly, m threshold value generation units, which respectively correspond to the plurality of comparing devices 420_1 to 420_m, may be provided in a single unsharpening kernel.

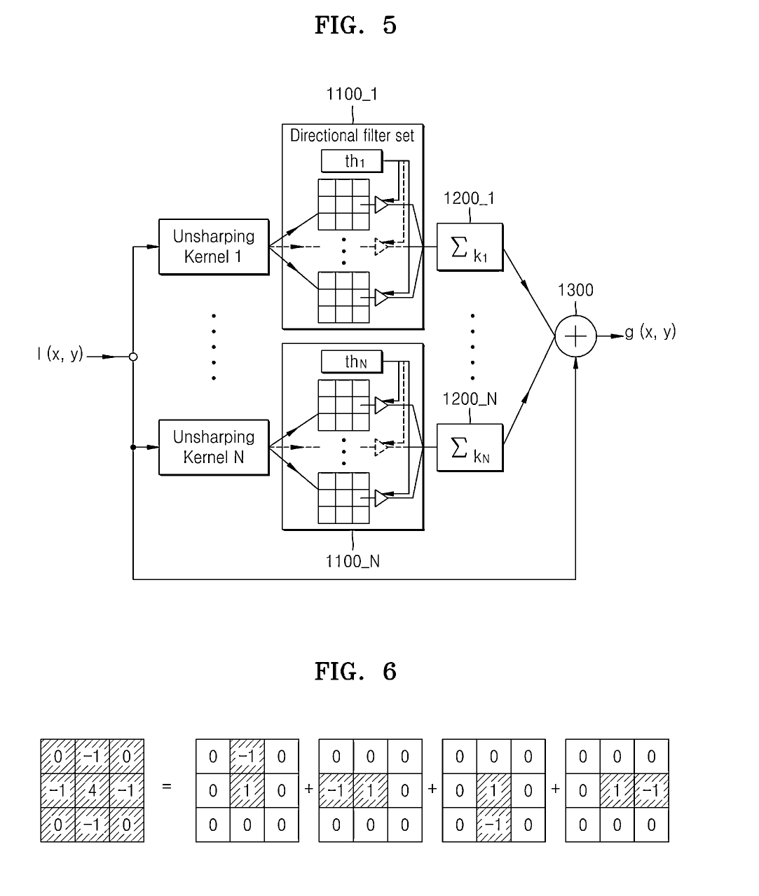

FIG. 4 is a detailed exemplary block diagram of a sharpening filtering unit 1000 according to an exemplary embodiment of the inventive concept. Since a multi-scale unsharpening filtering is included in FIG. 4, FIG. 4 illustrates an example where a plurality of (e.g., N, where N is an integer equal to or greater than 2) unsharpening kernels are included in the sharpening filtering unit 1000.

The sharpening filtering unit 1000 may include first to N-th unsharpening kernels, and input image data (I(x,y)) may be provided to the first to N-th unsharpening kernels. The first to N-th unsharpening kernels may include a plurality of directional filter sets 1100_1 to 1100_N and a plurality of aggregation devices 1200_1 to 1200_N. Also, the sharpening filtering unit 1000 may further include an adding device 1300 for adding outputs of the first to N-th unsharpening kernels. An output of the adding device 1300 may be provided as output image data (g(x,y)) that corresponds to the input image data I(x,y).

The plurality of directional filter sets 1100_1 to 1100_N included in each of the first to N-th unsharpening kernels may include a threshold value generation unit, a directional filtering unit, and a comparing unit. For example, a first unsharpening kernel may include a first threshold value generation unit 1110, a directional filtering unit 1120, and a comparing unit 1130. The directional filtering unit 1120 may include a plurality of directional filters having coefficients related to execution of the unsharpening filtering algorithm. For example, m directional filters (where m is an integer equal to or greater than 2) may be included in the directional filtering unit 1120. As described in the exemplary embodiments above, the same number of comparing devices and directional filters may be provided. Accordingly, the comparing unit 1130 may include m comparing devices.

The first threshold value generation unit 1110 may generate a threshold value that corresponds to a first unsharpening kernel. When the directional filtering unit 1120 may include a plurality of directional filters, the threshold value generation unit 1110 may generate threshold values that respectively correspond to the plurality of directional filters. For example, different threshold values or an identical threshold value may be generated with respect to the plurality of directional filters.

The comparing devices included in the comparing unit 1130 may compare outputs of corresponding directional filters and received threshold values. Thus, outputs are generated according to the comparison results. For example, when output values of the plurality of directional filters are smaller than corresponding threshold values, it is determined that sharpening noise has occurred in directions respectively corresponding to the plurality of directional filters. Thus, the sharpening noise may be removed (or reduced) from an output image. On the other hand, when the output values of the plurality of directional filters are equal to or greater than the corresponding threshold values, the respective output values may be provided as output values that represent a degree of edges in directions that respectively correspond to the plurality of directional filters. In other words, when output values from the corresponding directional filters are equal to or greater than a threshold value, the comparing devices included in the comparing unit 1130 may selectively provide the output values to the aggregation device 1200_1.

Therefore, only some output values of the plurality of directional filters included in each of the N unsharpening kernels may be aggregated, and the aggregation results of the N unsharpening kernels are provided to the adding device 1300. An output value of the adding device 1300, i.e., output image data (g(x,y)), may be provided as a final sharpening processed value.

According to the above-described embodiments, directional filtering operations are executed using sharpening operations, without using a separate edge detection filter. Thus, consumption of filtering resources is reduced, increase of sharpening noise is prevented, and low contrast edges are enhanced.

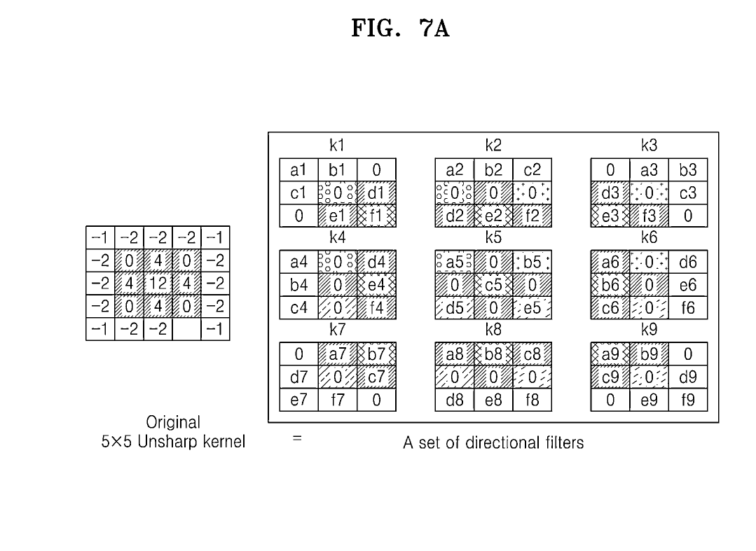

FIGS. 5, 6, 7A and 7B are block diagrams of an exemplary embodiment of the sharpening filtering unit 1000 of FIG. 4. As illustrated in FIG. 5, the sharpening filtering unit 1000 may include N unsharpening kernels. Each of the N unsharpening kernels may include a directional filter set, include a plurality of directional filters, and an aggregation unit. For example, a first unsharpening kernel may include a first directional filter set 1100_1 and a first aggregation unit 1200_1. The first directional filter set 1100_1 may include the plurality of directional filter in the above-described embodiments. Although it is illustrated that comparing devices and a threshold value generation unit are included in each directional filter set, the comparing devices and the threshold value generation unit may be disposed outside the directional filter set.

The first directional filter set 1100_1 may include comparing devices that respectively correspond to the plurality of directional filters. Also, the first directional filter set 1100_1 may include a threshold value generation unit for providing a threshold value to each comparing device. In addition, an aggregation device 1200_1 may be provided for aggregating at least some output values of the plurality of directional filters according to a comparison result obtained using a threshold value with respect to each of the N unsharpening kernels, and the adding device 1300 for generating output image data (g(x,y)) by adding outputs of a plurality of aggregation devices.

An edge component of an image may be amplified according to an unsharpening filtering algorithm executed in each of the N unsharpening kernels, and the unsharpening filtering algorithm may correspond to Equation 1 below. In Equation 1, “g(x,y)” refers to a sharpening processed image of an original image (I(x,y)), “Cn” refers to a sharpening gain. Also, “LPn(I(x,y))” refers to a spatial low pass filter operator regarding a scale number “n”.

g(x,y)=I(x,y)+Cn(I(x,y)−LPn(I(x,y))) [Equation 1]

The unsharpening filter for executing the unsharpening filtering algorithm may have a mask coefficient for executing a calculation corresponding to “I(x,y)−LPn(I(x,y))” in Equation 1 above. The unsharpening filter may be divided into a plurality of directional filters. In this case, the mask coefficient of the unsharpening filter may be the same as a total sum of filter coefficients of the plurality of directional filters. For example, as illustrated in FIG. 6, in a case where a filter corresponding to the unsharpening kernel is a 3*3 filter having a coefficient shown in FIG. 6, the unsharpening kernel may be divided into a plurality of (e.g., 4) directional filters. A total sum of coefficients of all directional filters may be the same as the mask coefficient of an unsharpening kernel. Also, a single unsharpening kernel may be divided into a plurality of directional filters according to a plurality of directions, e.g., a plurality of directional filters for detecting edges in horizontal and vertical directions as illustrated in FIG. 6.

FIGS. 7A and 7B illustrate examples of an unsharpening kernel having a size of 5*5. As illustrated in FIG. 7A, the unsharpening kernel may include a directional filter set that includes a plurality of directional filters. In addition, the unsharpening kernel may include a threshold value generation unit or comparing devices as in the above-described embodiments. FIG. 7B illustrates an exemplary embodiment in which the unsharpening kernel further includes a residual kernel other than the plurality of directional filters. In FIG. 7A, a mask filter value of the unsharpening kernel and a total sum of filter values of the plurality of directional filters may be the same. Alternatively, as shown in FIG. 7B, the mask filter value of the unsharpening kernel may be the same as a total sum of filter values of the plurality of directional filters and a filter value of the residual kernel.

The number of the plurality of directional filters may vary according to a filter value. Although FIGS. 7A and 7B illustrates that the unsharpening kernel having a 5*5 filter value is divided into nine directional filters, the exemplary embodiments of the inventive concept are not limited thereto. When the unsharpening kernel is divided into the plurality of directional filters, respective directions and locations of the plurality of directional filters may be adjusted. For example, the plurality of directional filters may be determined by adjusting coefficients of the plurality of directional filters. When the plurality of directional filters are determined, a coefficient of the residual filter is determined. Accordingly, a coefficient of an original unsharpening kernel may be a same coefficient as coefficients of the predetermined directional filters.

Edge detection directions of the plurality of directional filters may be determined in various ways. For example, the plurality of directional filters of FIGS. 7A and 7B may be diagonal type filters for detecting edges in diagonal directions, and horizontal and vertical type filters for detecting edges in horizontal and vertical directions. When determining respective locations of the plurality of directional filters, four diagonal type filters may be disposed in four corners of the original unsharpening kernel, and horizontal and vertical type filters may be respectively disposed in horizontal and vertical directions of the original unsharpening kernel. In addition to the above-described embodiments, appropriate directional filter sets having various forms may be extracted from the original unsharpening kernel.

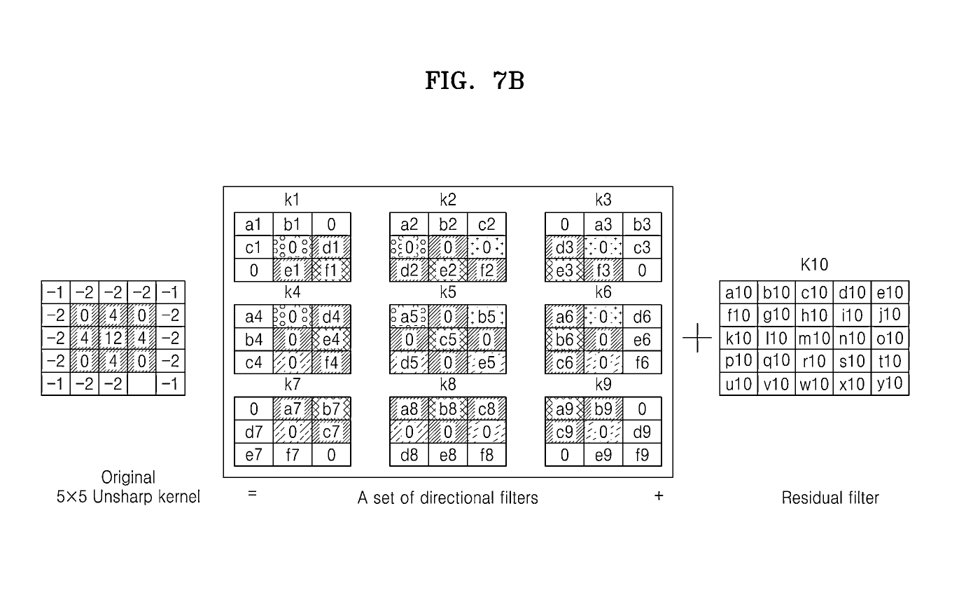

FIG. 8 is a view of images that have undergone an unsharpening filtering process according to an exemplary embodiment of the inventive concept. In FIG. 8, (a) to (c) represent unsharpening filtering results according to the exemplary embodiments of the inventive concept. In FIG. 8, (d) to (f) represent unsharpening filtering results according to the related art. Also, the unsharpening filtering results shown in(a) to (f) of FIG. 8 have different filter sizes. For example, a filter size in (a) and (d) of FIG. 8 may be 9*9, a filter size in(b) and (e) of FIG. 8 may be 5*5, and a filter size in (c) and (f) of FIG. 8 may be 3*3. According to a filtering result shown in FIG. 8, edge components of the image are enhanced and sharpening noise is reduced by executing an unsharpening filtering operation according to the exemplary embodiments of the inventive concept.

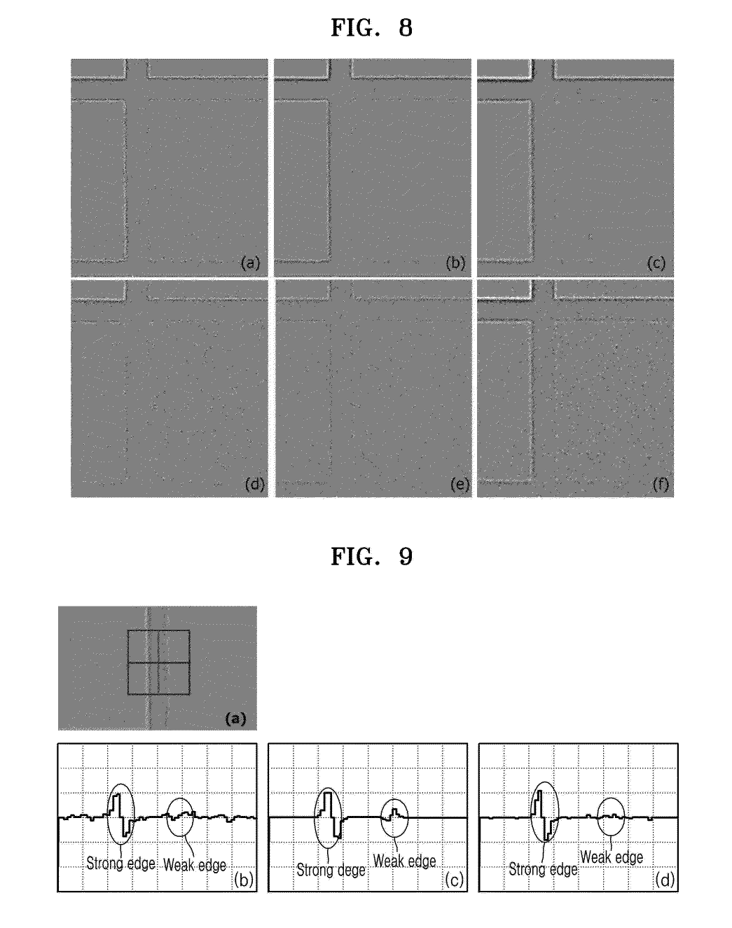

FIG. 9 is a view of a change in a low contrast edge profile according to the unsharpening filtering process according to an exemplary embodiment of the inventive concept. In FIG. 9, (a) is a sharpening map showing an edge profile box, and (b) is an edge profile image having sharpening noise and low contrast edges. As shown in (c) of FIG. 9, an unsharpening result according to the exemplary embodiments of the inventive concept illustrates that edges are enhanced and low contrast edges remain. However, as shown in (d) of FIG. 9, an unsharpening filtering result according to the related art shows that low contrast edges are reduced.

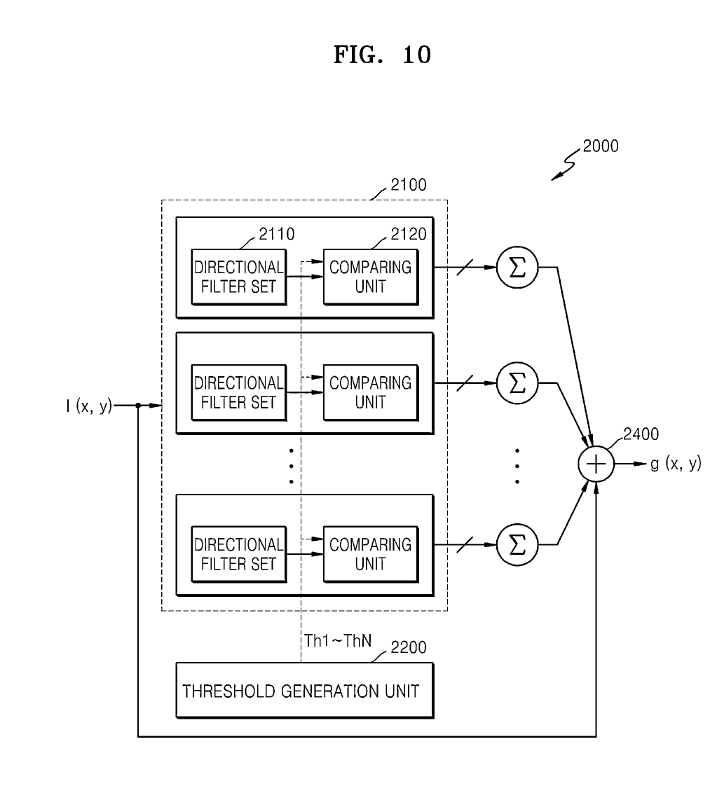

FIG. 10 is a block diagram of a sharpening filtering unit 2000 according to another exemplary embodiment of the inventive concept. As illustrated in FIG. 10, the sharpening filtering unit 2000 may include a filter set unit 2100 that includes a plurality of directional filter sets that correspond to a plurality of unsharpening kernels, and an aggregation unit 2300 in which a plurality of aggregation devices are provided with respect to each of the directional filter sets, and a threshold value generation unit 2200 that generates a threshold value with respect to each of the unsharpening kernels. In addition, the sharpening filtering unit 2000 may further include an adding device 2400 that adds output results of the plurality of aggregation devices that are included in the aggregation unit 2300. The sharpening filtering unit 2000 may provide in a multi-scale manner input image data (I(x,y)) to each of the unsharpening kernel, and also provide an output of the adding device 2400 as final output image data (g(x,y)).

As presented in the above-described embodiment, a directional filter set 2110 included in each kernel may include a plurality of directional filters for detecting various types of edges. Also, as described above, when determining filter coefficients and locations of the plurality of directional filters, the plurality of directional filters may be determined such that a mask coefficient of an unsharpening filter is equal to a total sum of coefficients of the plurality of the directional filters. For example, in FIG. 10, a first unsharpening kernel may include a directional filter set 2110 and a comparing unit 2120. The directional filter set 2110 may include a plurality of directional filters (e.g., m directional filters, where m is an integer equal to or greater than 2). The comparing unit 2120 may include m comparing devices that receive outputs of the plurality of m directional filters.

The threshold value generation unit 2200 may be disposed outside the plurality of unsharpening kernels and generate threshold values that respectively correspond to each of the directional masks. As presented in the above-described embodiments, the threshold value generation unit 2200 may generate the threshold values with respect to the plurality of m directional filters. For example, different threshold values or an identical threshold value may be generated with respect to the plurality of m directional filters. Alternatively, different threshold values or an identical threshold value may be generated with respect to each of the unsharpening kernels.

The comparing devices included in the comparing unit 2120 may receive and compare outputs of corresponding directional filters and threshold values, and generate different values according to the comparison results. For example, when an output of a directional filter is equal to or greater than a threshold value, the output of the directional filter may be output as a comparison result so as to enhance an edge in a direction that corresponds to the directional filter. Alternatively, when the output of the directional filter is smaller than the threshold value, it may be assumed that noise has occurred in an image. Accordingly, an output of a comparing device may be determined as being equal to “0” and output.

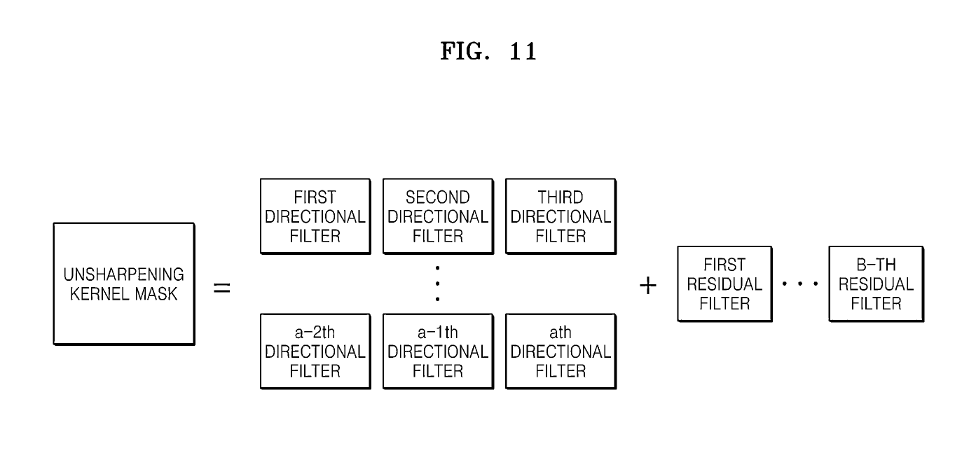

FIG. 11 is a block diagram of filters composing the unsharpening kernel according to an exemplary embodiment of the inventive concept. As illustrated in FIG. 11, the plurality of directional filters may be determined by executing division operations in various ways according to a mask filter value for executing the unsharpening filtering algorithm in the unsharpening kernel. FIG. 11 illustrates an example in which an unsharpening kernel mask is divided into “a” directional filters and “b” residual filters.

According to an exemplary embodiment of the inventive concept, a size of the unsharpening kernel and respective sizes of the plurality of directional filters may be the same. In this case, at least one residual filter may be determined according to a result obtained by performing subtraction operations in relation to a mask coefficient of the unsharpening kernel and a total sum of coefficients of the plurality of directional filters. Alternatively, the size of the unsharpening kernel may be greater than the respective sizes of the plurality of directional filters, and respective locations of the plurality of directional filters may be determined appropriately. The at least one residual filter may be determined by aggregating the coefficients of the plurality of directional filters, and then performing subtraction operations in relation to the aggregation result and the mask coefficient of the unsharpening kernel. For example, a size of the at least one residual filter may be the same as the size of the unsharpening kernel.

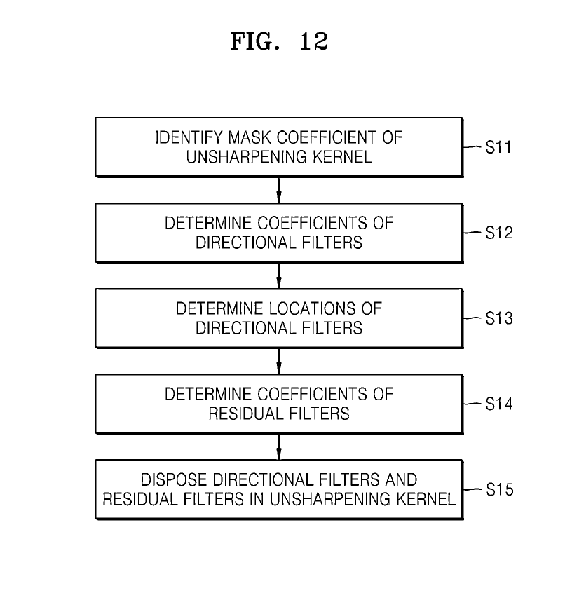

FIG. 12 is a flowchart of an image processing method using sharpening filtering according to an exemplary embodiment of the inventive concept. FIG. 12 illustrates an example of a method of determining the unsharpening kernel by dividing it into the plurality of directional filters.

First, a mask coefficient is identified according to the unsharpening filtering algorithm that is executed in the unsharpening kernel (S11). When the unsharpening kernel is divided into the plurality of directional filters, the coefficients of the plurality of directional filters are determined according to the identified mask coefficient (S12). The plurality of directional filters are for detecting at least one edge, and may be at least one of a horizontal type filter, a vertical type filter, and a diagonal type filter. In addition, respective locations of the plurality of directional filters may be determined such that the mask coefficient of the unsharpening kernel and a total sum of the coefficients of the plurality of directional filters are the same (S13).

However, the mask coefficient of the unsharpening kernel and the total sum of the coefficients of the plurality of directional filters may be different. In this case, the at least one residual filter may be used to equalize the two values. To equalize the two values, a coefficient of the at least one residual filter may be determined such that the coefficient is equal to a difference between the mask coefficient of the unsharpening kernel and the total sum of the coefficients of the plurality of directional filters (S14). When the plurality of directional filters and the at least one residual filter are determined as described above, the plurality of directional filters and the at least one residual filter are disposed in the unsharpening kernel so that an input image passes through these filters (S15).

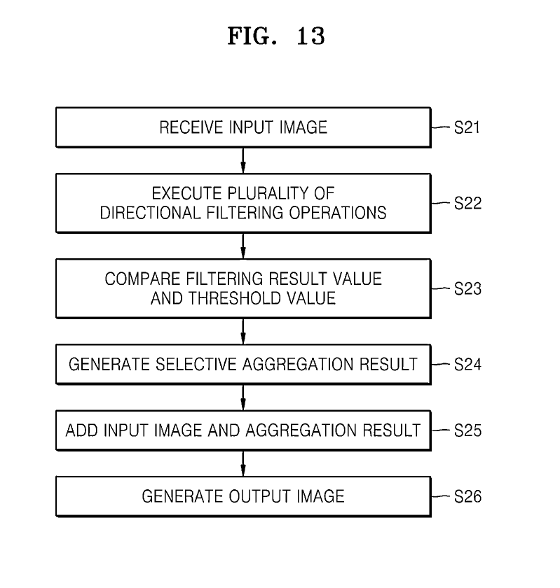

FIG. 13 is a flowchart an image processing method using sharpening filtering according to another exemplary embodiment of the inventive concept. FIG. 13 shows an example of a method of generating an output image by executing an unsharpening filtering process on the input image.

As illustrated in FIG. 13, the input image is received in a plurality of unsharpening kernels (S21), and the plurality of unsharpening kernels execute corresponding unsharpening filtering algorithms. To execute corresponding unsharpening filtering algorithms, each of the unsharpening kernels executes a plurality of directional filtering operations on the input image (S22), and outputs the plurality of directional filters provided to corresponding comparing devices. In addition, at least one threshold value is generated and provided to the comparing devices, and the comparing devices compare outputs of corresponding directional filters and the at least one threshold value (S23).

According to the comparison result, some outputs of the plurality of directional filters may be equal to or greater than the at least one threshold value, but other outputs may be smaller. According to the comparison result, the comparing devices may selectively output the outputs of the plurality of directional filters, or determine the outputs as being equal to “0”. Aggregation devices may be disposed to correspond to the plurality of directional filters, and may selectively aggregate some outputs of the plurality of directional filters according to the comparison result (S24). Then, an adding device adds the selective aggregation result of the plurality of unsharpening kernels and the input image (S25). The addition result may be provided as an output image that is generated by passing the input image through the plurality of unsharpening kernels (S26).

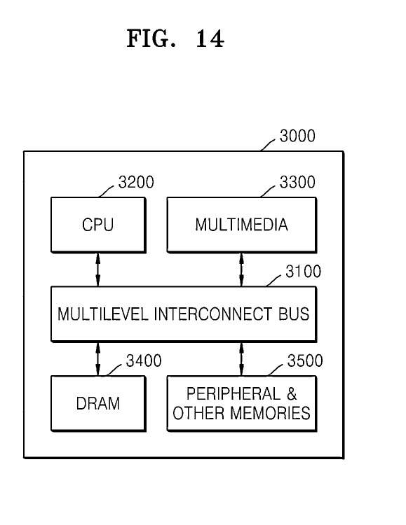

FIG. 14 is a block diagram of an application processor 3000 including the image processing apparatus according to an exemplary embodiment of the inventive concept. The application processor 3000 of FIG. 14 may be implemented in various forms, e.g., by using a system on chip (SoC). The SoC is implemented by integrating various functional systems in a single semiconductor chip, and a plurality of Intellectual Properties may be integrated into the SoC. The plurality of Intellectual Properties are provided in the SoC and execute particular functions thereof.

The application processor 3000 may include various Intellectual Properties (IP), e.g., an interconnect bus 3100 as a system bus, a central processing unit (CPU) 3200, a multimedia unit 3300, a memory device 3400, and a peripheral circuit 3500 which are connected to the interconnect bus 3100.

The interconnect bus 3100 may be a bus based on a predetermined bus standard. For example, the bus standard may be Advanced Microcontroller Bus Architecture (AMBA) protocol of ARM Holding plc. The AMBA protocol bus type may include Advanced High-Performance Bus (AHB), Advanced Peripheral Bus (APB), Advanced eXtensible Interface (AXI), AXI4, AXI Coherency Extensions (ACE), etc. AXI is an interface protocol between the IPs, and performs functions such as multiple outstanding addressing and data interleaving. In addition, other types of protocols, such as uNetwork of SONICs Inc., CoreConnect of IBM, and Open Core Protocol of Open Core Protocol International Partnership Association, Inc. (OCP-IP), may be used.

The Intellectual Properties shown in FIG. 14 may be implemented as functional blocks that execute unique functions. For example, the CPU 3200 may be a master IP and control operations of the application processor 3000. The multimedia unit 3300 may include an image encoder and/or an image decoder. Also, the multimedia unit 3300 may execute filtering operations on an image according to the above-described embodiments. For example, the multimedia unit 3300 may perform a filtering operation on an image through an unsharpening kernel by using a plurality of directional filters and at least one residual filter. The memory device 3400 is for temporarily storing information related to the operations of the application processor 3000, and may include a memory such as dynamic random access memory (DRAM). The peripheral circuit 3500 may include various interface means for interfacing with external devices, and may include various peripheral devices for implementing functions of the application processor 3000. For example, the peripheral circuit 3500 may include a memory other than DRAM, or means for accessing an external storage device.

The application processor 3000 may be provided in various terminals such as a mobile device and function as a main processor. The multimedia unit 3300 may provide an original image by decoding an encoded bitstream that is provided to the mobile device, and may encode an original image in the mobile device and provide it as an encoded bitstream. Also, as described above, the multimedia unit 3300 may use the plurality of directional filters and execute a selective aggregation operation based on a comparison result between the outputs of the plurality of directional filters and the at least one threshold value. Accordingly, low contrast edges may be enhanced and sharpening noise may be reduced.

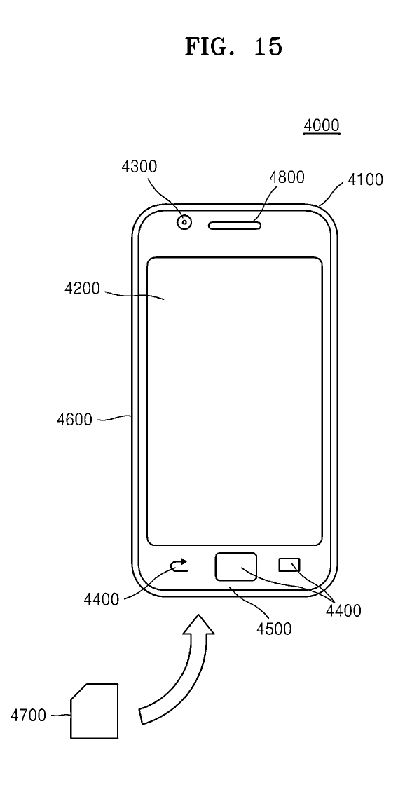

FIG. 15 is an exemplary view of a mobile device 4000 including the image processing apparatus according to an exemplary embodiment of the inventive concept. The mobile device 4000 of FIG. 15 may include the application processor 3000 of FIG. 14. The mobile device 4000 may be a smart phone having an unlimited number of functions by changing or expanding its functions using application programs. The mobile device 4000 includes an internal antenna 4100 for exchanging radio frequency (RF) signals with wireless base stations, and a display screen 4200 for displaying images captured by a camera 4300 or images received and decoded by the internal antenna 4100, such as a liquid crystal display (LCD) screen and an organic light-emitting diode (OLED) screen. The mobile device 4000 may include an operation panel 4400 that includes control buttons and a touch panel. When the display screen 4200 is a touch screen, the operation panel 4400 may further include a touch sensor panel of the display screen 4200. The mobile device 4000 includes a speaker 4800 or other type of audio output unit for outputting and sound signal, and a microphone 4500 or other type of audio input unit for inputting sound signal. The mobile device 4000 includes the camera 4300, such as a charge-coupled device (CCD) camera, for capturing videos and still images. In addition, the mobile device 4000 may include a storage medium 4700 for storing encoded or decoded data, such as videos or still images obtained by capturing, via e-mail, or in other ways, and a slot 4600 for mounting the storage medium 4700 in the mobile device 4000. The storage medium 4700 may be a flash memory such as a secure digital (SD) card or an electrically erasable and programmable read-only memory (EEPROM) equipped in a plastic case.

While the inventive concept has been particularly shown and described with reference to exemplary embodiments thereof, it will be understood that various changes in form and details may be made therein without departing from the spirit and scope of the following claims.

What is claimed is:

1. An image processing method comprising:
filtering input image data using a plurality of directional filters;
comparing a plurality of filtering results with a threshold value that corresponds to the filtering results;
selectively aggregating a plurality of output values of the directional filters according to results of the comparison; and
performing a first calculation on the input image data and a result of the selective aggregation.

2. The method of claim 1, wherein the performing the first calculation comprises generating output image data by adding the input image data and the result of the selective aggregation.

3. The method of claim 1, wherein a total sum of filtering coefficients of the directional filters is equal to a mask coefficient of an unsharpening kernel.

4. The method of claim 1, wherein the filtering further comprises filtering at least one filtering result obtained with the directional filters by using at least one residual filter.

5. The method of claim 4, wherein a total sum of filter coefficients of the directional filters and a filter coefficient of the at least one residual filter is equal to a mask coefficient of an unsharpening kernel.

6. The method of claim 1, wherein the directional filters comprises at least one of a horizontal type filter, a vertical type filter, and a diagonal type filter.

7. The method of claim 1, wherein the directional filters comprise m directional filters and m comparing devices which correspond to the m directional filters,
wherein output values of less than m directional filters are aggregated according to the results of the comparison, and
wherein m is an integer equal to or greater than 2.

8. The method of claim 1, wherein N unsharpening kernels receive the input image data and execute an unsharpening filtering algorithm,
wherein the directional filters and a plurality of comparing devices for performing comparison operations are provided in each of the N unsharpening kernels, and
wherein N is an integer equal to or greater than 2.

9. The method of claim 8, wherein the result of the selective aggregation is provided from each of the N unsharpening kernels, and
wherein the performing the first calculation comprises adding the input image data and the result of the selective aggregation of a N number of unsharpening kernels.

10. The method of claim 1, wherein a plurality of comparing devices are provided with respect to the directional filters, and
wherein an identical threshold value or a plurality of different threshold values are provided to the comparing devices.

11. The method of claim 1, wherein each of the comparing devices outputs an output value of a corresponding directional filter in response to the output value of the corresponding directional filter being equal to or greater than a threshold value, and outputs a value equal to 0 in response to the output value of the corresponding directional filter being less than the threshold value.

12. An image processing apparatus comprising:
at least one unsharpening kernel configured to execute an unsharpening filtering algorithm; and
a calculator configured to generate output image data by performing a first calculation on an output of the at least one unsharpening kernel and input image data,
wherein the at least one unsharpening kernel comprises:
a directional filter set which comprises a plurality of directional filters for filtering the input image data;
a comparing unit which comprises a plurality of comparing devices respectively provided with respect to the directional filters, and configured to compare a plurality of filtering results with a threshold value that corresponds to results of the filtering; and
an aggregation device configured to aggregate a plurality of output values of the directional filters according to results of the comparison from the plurality of comparing devices, and provide an aggregation result as an output of the at least one unsharpening kernel.

13. The apparatus of claim 12, further comprising a threshold value generation device configured to provide a threshold value to each of the comparing devices.

14. The apparatus of claim 12, wherein the at least one unsharpening kernel further comprises at least one residual filter that filters output values of the directional filters.

15. The apparatus of claim 12, wherein the directional filters comprise at least one of a horizontal type filter, a vertical filter, and a diagonal type filter.

16. An image processing method comprising:
identifying a mask coefficient of an unsharpening kernel according to an unsharpening filtering algorithm;
determining a plurality of coefficients of a plurality of directional filters based on the identified mask coefficient;
determining a plurality of locations which correspond to the directional filters;
determining a coefficient of at least one residual filter such that the coefficient is equal to a difference between the identified mask coefficient and a total sum of the coefficients of the directional filters; and
disposing the directional filters and the at least one residual filter in the unsharpening kernel such that an input image passes through the directional filters and the at least one residual filter.

17. The method of claim 16, wherein the unsharpening filtering algorithm is executed in the unsharpening kernel.

18. The method of claim 16, wherein the unsharpened kernel is divided into the directional filters.

19. The method of claim 16, wherein the directional filters comprise at least one of a horizontal filter, a vertical filter, and a diagonal filter.

20. The method of claim 16, wherein the directional filters are configured to detect at least one edge.
